(19) United States
(12) Patent Application Publication
(10) Pub. No.: US 2025/0351252 A1
(43) Pub. Date: Nov. 13, 2025

(54) ADAPTIVE LIGHT FIXTURE WITH STANDBY FEATURE

(71) Applicant: GLOBE ELECTRIC COMPANY INC., Montreal (CA)

(72) Inventors: John Colvin Deaton, Bowling Green, KY (US); Scott Blaise Tylicki, Bowling Green, KY (US); Diana Cedeno Cardenas, Montreal (CA); Steve Busby, Montreal (CA); Diana Garcia Ramirez, Montreal (CA); Greta Palaez Heredia, Beaconsfield (CA)

(21) Appl. No.: 19/204,052

(22) Filed: May 9, 2025

Related U.S. Application Data
(60) Provisional application No. 63/646,351, filed on May 13, 2024.

(51) Int. Cl. H05B 47/17; H02J 7/00; H05B 39/06; H05B 45/10; H05B 47/115

(52) U.S. Cl. CPC H05B 47/17; H02J 7/0068; H05B 39/06; H05B 45/10; H05B 47/115

(57) ABSTRACT

An illumination apparatus which has a standby feature whereupon switching off the light fixture, minimal standby feature operations may be implemented using an alternative power source. By turning off the light switch, the light fixture may switch from a first operating mode, such as an illumination mode, into a standby mode. While in standby mode, the light fixture may operate in the standby mode connected to a secondary power supply, such as a battery. While in the standby mode, the light fixture may operate to conserve power while ensuring that the sensor can operate along with a subset of the control circuit. Upon detection of motion while in standby mode, the secondary power supply may work in conjunction with the standby circuit to power a single, or all of the, light source(s) at a lower output powered only by the secondary power supply.

### BACKGROUND

Illumination systems which have multiple operating modes are beneficial due to the varying needs of lighting. This may be particularly relevant for illumination systems that have both normal and low lighting goals. Further, battery or alternative powered standby operation may be desirable to provide low level illumination in occupied areas.

### SUMMARY

The specification is directed towards an illumination apparatus which has standby features where, upon switching off the light fixture and disconnecting it from the primary power supply such as household line voltage, minimal standby feature operations may be implemented using an alternative power source. The lighting apparatus may be an adaptive light fixture that includes at least a first illumination source and a second illumination source. These lights (illumination sources), whether individually or combined, can be attached or integrated with a fixture housing. The fixture housing can have control circuitry and an alternative power source therein or integrated therewith. The control circuitry can be an integrated controller circuit and can include one or more sensors electronically connected or in communication with the control circuitry. The sensors can alternatively be attached to the inside of the fixture housing, electronically connected to the control circuit, and have a line of sight to an illumination area. The control circuit can be electrically connected to the first illumination source, the second illumination source, an external power source such as line voltage, and an internal battery attached to the inside of the fixture housing. The light fixture can be electrically connected to a standard light switch that connects or disconnects the light source from a connected power supply such as line voltage. By turning off the light switch, the light fixture may switch from a first operating mode, such as an illumination mode, into a standby mode. While in the illumination mode, a primary circuit of the control circuit or microcontroller can operate the first illumination source with power supplied by an external power source. The external power source can additionally charge the battery while the light fixture is in the illumination mode. While in standby mode, which may be activated by turning off the light switch or which may be actuated remotely, the light source may be disconnected, by, for example, a standard switch, from the wired connected power supply, such as line voltage, and the light fixture may operate in the standby mode connected to a secondary power supply, such as a battery. While in the standby mode, the light fixture may operate to conserve power while ensuring that the sensor, such as a motion, PIR and/or photometric sensor, can operate along with a secondary circuit of the control circuit. The secondary circuit of the control circuit or microcontroller may be a standby circuit which minimizes power consumption. Upon detection of motion while in standby mode, and wherein the light fixture is effectively disconnected from the primary power source powering the first operating mode, the secondary power supply may work in conjunction with the secondary circuit to power a portion or all of the light sources at a lower output powered only by the secondary power supply.

In various implementations, one or more of the sensors can be a motion detector and one or more of the sensors can be a light detector. The first illumination source and the second illumination source can be different types, and further one of the light sources may be brighter than the others and potentially have different loads. One of the illumination sources can be powered by the external power source while another of the illumination sources can be powered by the internal battery. Alternatively, all the illumination sources may be connected to the power supply and controller by drivers and/or control circuitry at the same or at varying output intensities depending on the operation mode.

In some implementations, the adaptive light fixture can include one or more dimmable illumination sources integrated with a fixture housing. The fixture housing can include a control circuit that can be wired to an external power source, an internal power source inside the fixture housing, one or more of the illumination sources, motion sensors, and/or light sensors. The motion sensors and light sensors can be visible through an aperture in the fixture housing or may be remotely positioned but in electronic communication.

The motion sensor can be an infrared sensor and the light sensor can be a photodiode. Additionally, if there is a plurality of dimmable illumination sources, then the dimmable illumination sources can be different types of dimmable illumination sources. The adaptive light feature may alternatively include one or more non-dimmable illumination sources that are integrated with the fixture housing and electrically connected to the control circuit.

In some implementations, the user can control the illumination source by extinguishing, in response to an input received from the user, a first lightbulb of a light fixture. A light sensor, such as a photodiode, can provide a signal to a control circuit that can receive the signal indicating that a brightness measure of light in an illumination area of the light fixture has fallen below a threshold light level. A motion sensor may provide signals to the control circuit indicating occupancy in the illumination area. For example, signals from the motion sensor can indicate movement of an entity in the illumination area of the light fixture by detecting temperature or actual movement using PIRs, cameras or other detectors.

An internal battery of the light fixture can be connected to the control circuit and/or secondary circuit as well as to the sensors and the illumination sources. In some implementations, the primary and the secondary illumination sources are the same type of illumination sources. In other implementations, the primary and the secondary light sources may be different. For example, the second light source may be an incandescent source or may be an LED, and in the standby mode, upon detection of movement, may be illuminated. The second light source, such as an incandescent bulb, can be dimmer than the first light source.

Input may be received from a user such as, for example, manipulation of a light switch into an “on” or “off” position and the secondary power source, such as a battery, can be charged by the external power source when in the “on” switch position and while the fixture is operating in an illumination mode. Input received from a user, such as when the switch is in the “off” position, can cause the fixture to enter standby mode wherein a first light source of the light fixture to be extinguished while maintaining operation of the control circuit or the secondary circuit to occur by connecting, as a power source, the internal battery. Alternatively, the input received from the user can be input from a remote control configured to control the light fixture. In some implementations, when in standby mode, minimal operation of the fixture may occur, such as lower light level illumination. For example, in implementations while the fixture is in standby mode, the illumination from the primary or first light sources may be extinguished and the sensors and secondary or standby circuit may be powered by the battery. When in such mode of operation, and upon detection of movement, lower level illumination may be initiated by the secondary or standby circuit to provide night-light type illumination. The illumination levels for primary or a first operation mode and the second or standby mode may be the same or different, but in examples the second or standby mode may utilize lower level illumination utilizing a secondary light source at a lower illumination level for a predetermined amount of time after movement is detected. This illumination interval in the standby mode may be set by the user or may be preset intervals.

In various implementations, disclosed herein is an adaptive light fixture which includes a first illumination source and a second illumination source and one or more sensors. Also included is an internal battery and a control circuit electrically connected to the first illumination source, the second illumination source, an internal battery, wiring for an external power source, and the one or more sensors. In various configurations, the control circuit may include a primary circuit that controls the first illumination source when the adaptive light fixture is in a first operating mode, wherein the primary circuit is electrically connected to the external power source. The control circuit may also include a connection to the external power source controlled by an external power switch that is in electrical communication with the control circuit, wherein the internal battery is in electrical connection with the external power source. There may also be included a secondary circuit that controls at least the second illumination source when the adaptive light fixture is in a second operating mode wherein the internal battery is electrically connected to the secondary circuit when the adaptive light fixture is in the second operating mode.

In such implementations, the adaptive light fixture may have one or more of the sensors which include a motion detector. Other implementations may incorporate one or more of the sensors as a photodiode. Implementations may further include a first illumination source and the second illumination source which each have different types of light sources. Even further embodiments may include a first illumination source which is brighter than the second illumination source. Still further implementations may include a first illumination source which is electrically connected to the external power source and the second illumination source is powered by the internal battery. Further implementations may include an external power switch which has a remote control to control the functionality of the fixture and controller.

In still further embodiments, the present disclosure describes an adaptive light fixture which has one or more dimmable illumination sources and a motion sensor and a light sensor. The light fixture may further include a control circuit electrically connected to the one or more dimmable illumination sources, wiring for an external power source, an internal power source, the motion sensor, and the light sensor, wherein the control circuit includes, among other options, a primary circuit that controls one or more of the dimmable illumination sources when the adaptive light fixture is in a first operating mode, wherein the primary circuit is connected to the external power source. In aspects, the connection to the external power source is controlled by an external power switch that is in electrical communication with the control circuit, wherein the internal power source is in electrical connection with the external power source. Still further aspects include a secondary circuit that controls one or more of the dimmable illumination sources when the adaptive light fixture is in a second operating mode, where the internal power source is electrically connected to the secondary circuit when the adaptive light fixture is in the second operating mode.

In still further embodiments, the light fixture may also include a motion sensor which is an infrared sensor. Alternatively or in addition thereto, the light sensor may be a photodiode. Further embodiments may include a first dimmable illumination source of the one or more dimmable illumination sources which are a different type of illumination source than a second dimmable illumination source of the one or more dimmable illumination sources. Even further embodiments may include one or more non-dimmable illumination sources electrically connected to the control circuit.

Still further aspects of the present disclosure include a method for controlling function of a light fixture including extinguishing, in response to an input received from a user, a first illumination source of the light fixture; receiving, from a light sensor at a control circuit of the light fixture, a first signal that indicates that a brightness measure of light in an illumination area of the light fixture has fallen below a threshold light level; receiving, from a motion sensor at the control circuit of the light fixture, one or more second signals that indicates a movement of an entity in the illumination area of the light fixture; activating, in response to receiving the first signal and one or more of the second signals, an internal battery of the light fixture; and illuminating, in response to activating the internal battery, a second illumination source of the light fixture.

In further embodiments, the design may include a second illumination source is dimmer than the first illumination source. Other implementations include aspects where the input is received from the user as a manipulation of a light switch into an “off” position. Still further options may include an internal battery which is charged by an external power source.

Some further additions and/or options of the disclosure include aspects where the input received from the user causes the first illumination source of the light fixture to be extinguished while maintaining an electrical current flow from an external power source to charge the internal battery. Still further options include extinguishing the second illumination source in response to ceasing receiving one or more of the second signals. Still further options include aspects of extinguishing the second illumination source by ceasing the receiving one or more of the second signals for a threshold period of time. One other aspect may include the input received from the user as input from a remote control configured to control the light fixture.

The above description is provided as an overview of some implementations of the present disclosure. Further description of those implementations, and other implementations, are described in more detail below.

### BRIEF DESCRIPTION OF THE DRAWINGS

FIG. 1 depicts a front perspective view of an adaptive light fixture.

FIG. 2 depicts an example circuit schematic 202 of an adaptive light fixture 100.

FIG. 3 depicts a front perspective of an adaptive light fixture 100 when the light fixture 100 is operating in an illumination mode.

FIG. 4 depicts a front perspective of an adaptive light fixture 100 light when the fixture is operating in a standby mode.

FIG. 5 depicts a front perspective of an adaptive light fixture 100 when the light fixture 100 is operating in a nightlight mode.

### DETAILED DESCRIPTION

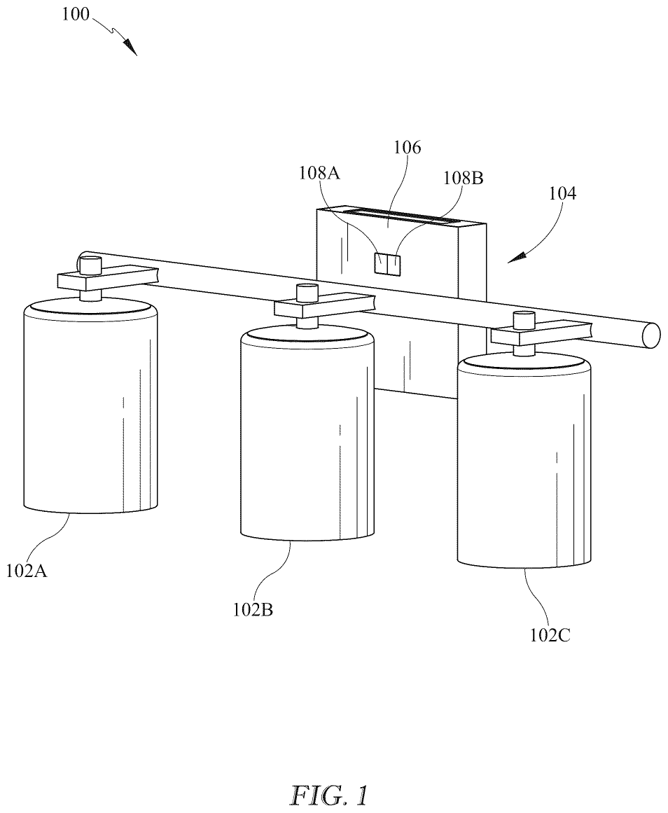

Turning now to FIG. 1, a front perspective view of an adaptive light fixture 100 is depicted. The adaptive light fixture 100 can include one or more illumination sources 102A-C secured to a frame 104. Each of the illumination sources 102A-C can operate at variable power levels such that they can emit varying intensities of light. The frame 104 can be used to secure the adaptive light fixture 100 to a surface. For example, the adaptive light fixture 100 can be a vanity light or a flood light and the frame 104 can be attached to a wall; the adaptive light fixture can be a ceiling light and the frame 104 can be attached to a ceiling; or the adaptive light feature 100 can be a table light and the frame 104 can be placed atop a table or desk surface.

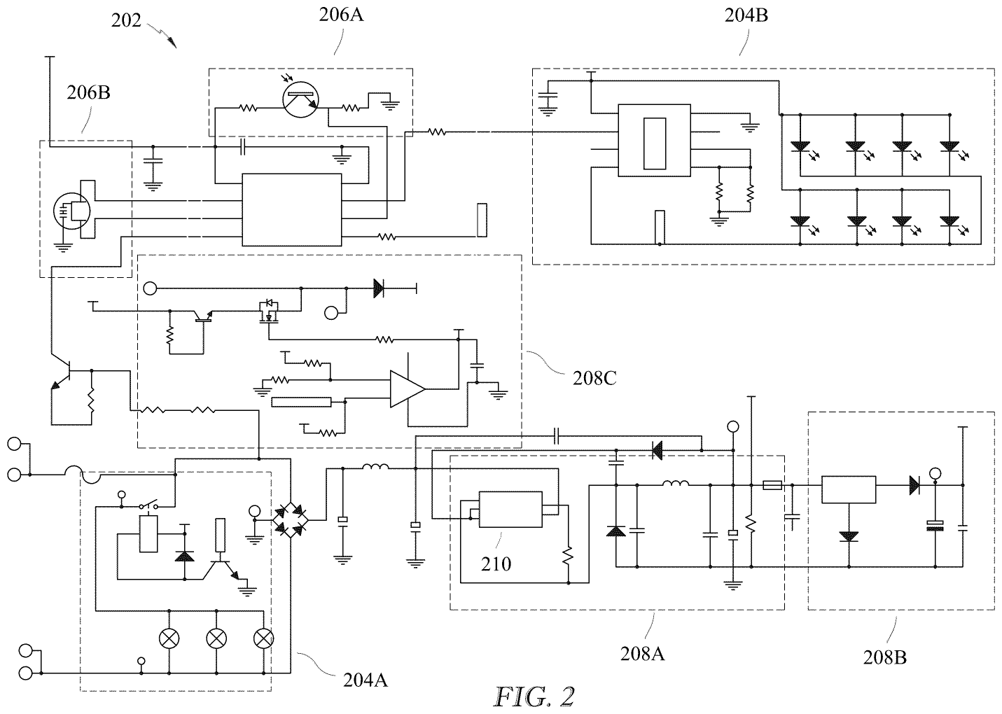

The frame 104 can include a fixture housing and/or mounting plate 106 that contains various electrical components that are described in greater detail with respect to FIG. 2. The fixture housing 106 can include one or more sensors 108A-B. The one or more sensors 108A-B can be integrated within the fixture housing 106 or attached to an inner wall of the fixture housing 106 and be visible through an aperture in the fixture housing 106 with a line of sight to an illumination area of the adaptive light fixture 100. The illumination sources 102A-C can be attached to or integrated with the fixture housing 106. The sensors may further include, along a front surface thereof, a lens which focalizes input in an observation area to the sensor behind the lens.

For example, in some implementations, the mounting plate 106 may include various electronic components such as printed circuit boards and micro-controllers, power supplies and power converters, electrical connections, mounting structures allowing the plate to be mounted against a wall or junction box, as well as other electrical components. In some implementations, electrical components maintained within the mounting plate can work independently of the drivers or other electronics necessary for the light fixture. For example, a remote control RF receiver may be provided which receives signals from a remote control device to receive operation commands for the fixture.

In other examples, the sensors may include photodiodes or thermal sensors such as PIR. These sensors may be mounted within the mounting plate and/or fixture housing 106 while receiving input from the external environment through the lens, shown in the figures on the surface of the housing.

In some implementations, a first sensor 108A of the one or more sensors 108A-B can have the ability to detect motion, such as an infrared sensor. Alternatively, another one of the sensors 108B of the one or more sensors 108A-B can detect light, such as a photodiode. The adaptive light fixture 100 can include one or more sensors 108A-B having the same or different functionalities.

In some implementations, each of the illumination sources 102A-C can include a single type of lightbulb, such as LED, CFL, halogen, incandescent, fluorescent, edison type, vintage, and or any other lightbulb type. Alternatively, the illumination sources 102A-C can include a combination of different types of lightbulbs. In various implementations, each of the illumination sources 102A-C can utilize a bulb that is capable of emitting light at varying levels of brightness.

Each of the illumination sources 102A-C can be powered by the same source or, alternatively, one or more of the illumination sources 102A-C can be powered by a different source than another of the illumination sources 102A-C. For example, illumination sources 102A and 102C may be powered by an external power source, such as line voltage that is electrically connected to the adaptive light fixture 100 while illumination source 102B may be powered by an internal power source such as a battery. The internal power source can be integrated into the fixture housing 106. Each of the illumination sources 102A-C can also use external power as the primary power source and the internal power source as a secondary power source. The internal power source, such as a battery can charge while the adaptive light fixture 100 is receiving power from the external power source.

In some implementations, the fixture housing may include a connection to line voltage and also provide other electronics for modifying the voltage and/or other power characteristics. For example, line voltage may be provided to the fixture housing through a mounting surface of a junction box and internal electronics may provide step-down voltage from the line voltage to the actual illumination sources. In some examples, low voltage power may be provided to the illumination sources during standard operating mode via circuits to modify the line voltage, typically 120 VAC, to lower voltage DC power. For example, a circuit may be utilized to modify input voltage to a lower voltage for powering the illumination sources. Such examples include LEDs which typically require a low voltage power supply for the drivers to operate as compared to incandescent bulbs.

FIG. 2 depicts a control circuit 202 of an adaptive light fixture 100. The control circuit 202 can be integrated inside the fixture housing. The control circuit 202 and its various components can be electrically connected to one or more of the illumination sources 102A-C, an internal power source such as a battery 210, and an external power source such as line voltage.

The electrical components of the adaptive light fixture 100 can include relay circuits and power supply circuits 204A-B. These circuits 204A-B can control the function of one or more of the lights 102A-C. For example, relay circuit 204A can control incandescent bulbs and nightlight power supply circuit 204B can control nightlight LEDs. In examples, relay circuit 204A can maintain power to the higher intensity light sources, lamps and/or bulbs shown in relay circuit 204A can be incandescent bulbs which are connected to 120 VAC wherein the three bulbs depicted may represent the lamps 102A, 102B and 102C. Hence, when standard line voltage is connected to the circuit and the switch is closed, the lights 102A, 102B and 102C will provide higher relative light output. Of course, the bulbs depicted in circuit 204A may instead be LEDs or other light sources with the appropriate drivers and power supply.

In the drawings, nightlight control circuit 204B may provide control and power to the LEDs which may represent a smaller load than the load within the relay circuit 204A.

In some implementations, the control circuit 202 can be divided into a primary circuit and a secondary circuit. The control circuit 202 can operate according to one or more modes of operation of the adaptive light fixture 100. For example, when the adaptive light fixture 100 is operating in a standard illumination mode, the relay circuit 204A can serve as a primary circuit. The relay circuit 204A can control one or more of the illumination sources 102A-C with power supplied by the external power source, such as line voltage. When the adaptive light fixture 100 operating in the higher output standard illumination mode, the external power source can also supply power to a battery charging and protection circuits 208A, 208B and 208C that are electronically connected to the external power source to charge an internal battery 210 of the adaptive light fixture 100. Hence, when operating in standard mode, dual functionality of charging and illumination may occur. Battery 210 may also be a high capacity rechargeable battery, such as a Li-Ion 3.7V 500 mAH rechargeable battery.

The adaptive light fixture 100 can also operate in a standby mode. In the standby mode, the external power source can be disconnected from the relay circuit 204A that is serving as the primary circuit, and the internal battery 210 can supply power to the nightlight power supply and light sources circuit 204B, which can serve as the secondary circuit, and/or one or more of the illumination sources 102A-C, and the sensor circuits 206A-B. For example, sensor circuit 206A may be a photodiode for ambient light detection. Further, for example, sensor detector 206B may be a PIR or other motion detection sensor. In some implementations of the standby mode, the external power source can continue to provide power to the battery protection and charging circuit 208A/B/C and battery 210. Alternatively, such as if a light switch were placed in the “off” position, the external power source can be cut off from the battery charging circuit 204A. While generally sensors may be non-functional while in standard illumination mode, sensor circuits 206A-B can alternatively continue to be powered by the external power source while in either operating modes. However, for typical design and operation, the sensor circuits 206A-B may be operational in standby mode and powered by the battery 210. A voltage regulation circuit 208B can regulate how much power is supplied from the internal battery 210 to the other components of the adaptive light fixture 100. Additional or alternative connections may be readily made from the voltage regulation circuit and battery 210 to other components of the light fixture which may not be shown in FIG. 2.

When the adaptive light fixture 100 is operating in the standby mode, the sensor circuits 206A-B can provide a signal to the nightlight circuit 204B, serving as the secondary circuit. The signals provided by the sensor circuits 206A-B can indicate that an entity has been detected in the illumination area of the adaptive light fixture 100, and/or that the amount of light in the environment of the adaptive light fixture 100 is below a particular illumination level. In some implementations, the signals provided by the sensor circuits 206A-B can cause the nightlight control circuit 204B to illuminate one or more of the illumination sources 102A-C. The relay circuit can control one or more of the illumination sources 102A-C to power one or more of the illumination sources 102A-C at a lower output than when the adaptive light fixture 100 is operating in the illumination mode. In other implementations, the illumination sources 102A-C can be primary incandescent bulbs, as depicted in relay circuit 204A separated from secondary illumination sources, such as LEDs. Secondary LEDs, in such implementations, may be provided as part of the illumination sources which are powered by the nightlight circuit 204B at a lower power than primary illumination sources 102A-C. Hence in some implementations, the illumination sources 102A-C may be separated to be controlled and electrically connected to circuit 204A, while secondary light sources adjacent or concurrent with sources 102A-C may be implemented as LEDs powered by nightlight control circuit 204B.

In desired implementations, the adaptive light fixture 100 depicted provides dual lighting for full power daytime lighting while in standard illumination mode and lower power nightlighting when in standby mode. Hence while the light switch 302 is in “on” position, the household electricity provides power to the fixture for daytime lighting in the standard illumination mode. When the light switch is in the “off” position the battery provides power to the fixture for nighttime lighting. The standby nighttime lighting can activate when the switch is in the OFF position and the photo-diode from sensor 206A detects night and motion is detected from sensor 206B.

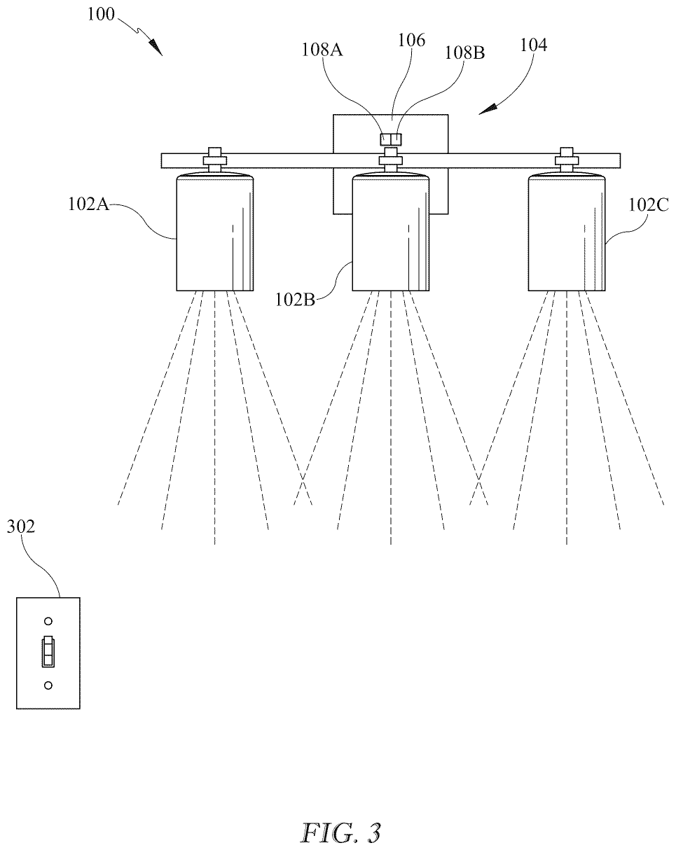

FIG. 3 depicts a front perspective of an adaptive light fixture 100 when the adaptive light fixture 100 is operating in an illumination mode. A switch 302 can be in the “on” position. The adaptive light fixture 100 can be electrically connected to an external power source, which can be controlled via the switch 302. When the switch 302 is in the “on” position, each of the illumination sources 102A-C can emit light at a predetermined intensity or brightness, receiving power from the external power source. For example, the switch 302 can be a single or double pole switch that, when flipped into the “on” position, causes the illumination sources 102A-C to emit light at the maximum intensity that the external power supply will allow. Alternatively, the switch 302 can be a dimmer switch, which can allow a user to adjust the brightness of the illumination sources 102A-C when the switch 302 is in the “on” position. The switch 302 can also be a timer that causes the illumination sources 102A-C to turn on at a particular time.

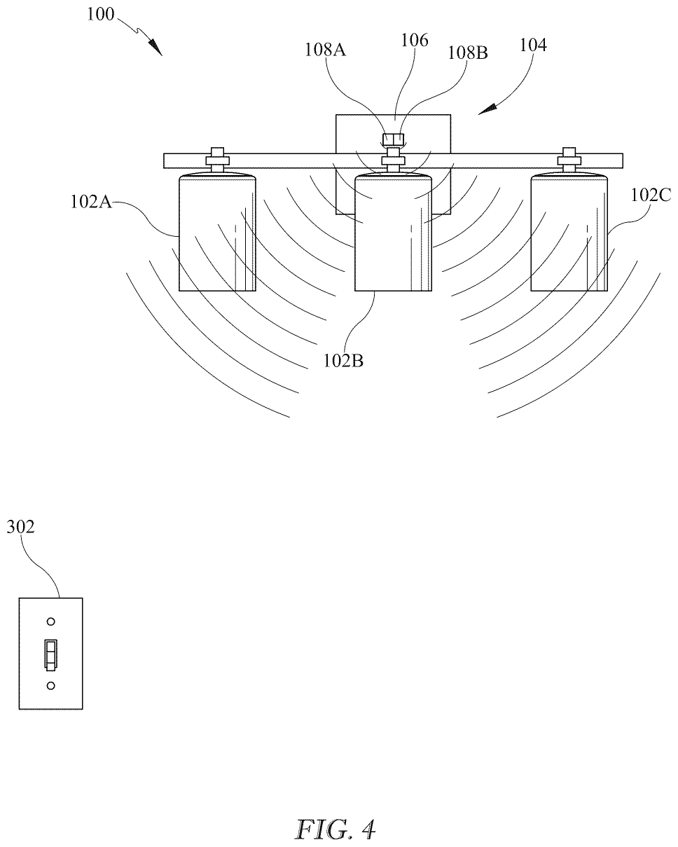

FIG. 4 depicts a front perspective of an adaptive light fixture 100 when the adaptive light fixture 100 is operating in a standby mode. A switch 302 can be in the “off” position and the illumination sources 102A-C can be extinguished. The switch 302 being in the “off” position can cut off the external power source from the illumination sources 102A-C. Alternatively, the adaptive light fixture 100 can be electronically connected to a timer that, after a period of time, or at a particular time, can cause the illumination sources 102A-C to turn off without the need for a user to flip a switch 302 or press a button. In some implementations, a sensor 108B, can include a photodiode that detects the amount of light in the illumination area. In some implementations, when the amount of light is below a particular threshold, the sensor 108B can cause the illumination sources 102A-C to turn off without the need for a user to flip a switch 302 or press a button.

When the adaptive light fixture 100 is operating in the standby mode, for example when the switch is placed in the “off” position, an internal battery 210 can supply various components of the adaptive light fixture 100 with power. For example, low power LEDs or alternatively one or more of the illumination sources 102A-C and one or more of the sensors 108A-B can receive power from the internal battery 210. As described with respect to FIG. 2, when the sensor 108A does not detect motion and/or if the amount of light in the illumination area of the adaptive light fixture 100 is above a particular level, the illumination sources 102A-C can remain extinguished.

In some implementations, when the adaptive light fixture 100 is operating in the standby mode and the light switch is in the “off” position, the low power LEDs or one or more illumination sources 102A-C can remain extinguished until motion detection sensor 108A detects movement in the illumination area around the adaptive light fixture 100. In some implementations, the sensor 108A can only detect motion when the switch 302 is in the “off” position and the sensor 108B detects that the amount of light in the illumination area of the adaptive light fixture 100 is below a particular threshold. In such circumstances, the light fixture may illuminate in nighttime mode with low level illumination emitted from the LEDs depicted in the nighttime power circuit 204B. Such LEDs can be placed anywhere adjacent to or concurrent with the light sources 102A/B/C. Alternatively, the sensor 108A can detect motion anytime that the illumination sources 102A-C are off, or the sensor 108A can operate continuously.

When a user wants to turn the illumination sources 102A-C off while in standard illumination mode but maintain charging of the battery, the user can use a switch 302 pattern. In normal operation, when the adaptive light fixture 100 receives external power and the switch is “on”, the internal battery 210 is charged while also powering the illumination sources 102A-. Alternatively, the user may desire to extinguish the illumination sources but continue to power and charge the battery 210. Such a pattern can identify such a “charging state”. For example, a user can flip the switch 302 from the “on” position to the “off” position and then back to the “on” position within a predetermined period of time. In response to the switch 302 pattern, the external power source can continue to charge the internal battery 210 of the adaptive light fixture 100 while one or more of the illumination sources 102A-C are not illuminated. The switch 302 pattern can also cause the sensor 108A and/or 108B to activate and begin detecting motion in the illumination area of the adaptive light fixture 100. In other implementations, a remote control can be used in place of the switch 302 to turn off the illumination sources 102A-C while keeping the external power supply charging the internal battery 210.

In some implementations, the adaptive light fixture 100 can include an indicator that the sensor 108A for detecting motion is activated and that one or more of the illumination sources 102A-C can be illuminated when motion is detected. For example, a flashing LED light, a solid LED light, or other indicators can be used to signal that the sensor 108A is activated.

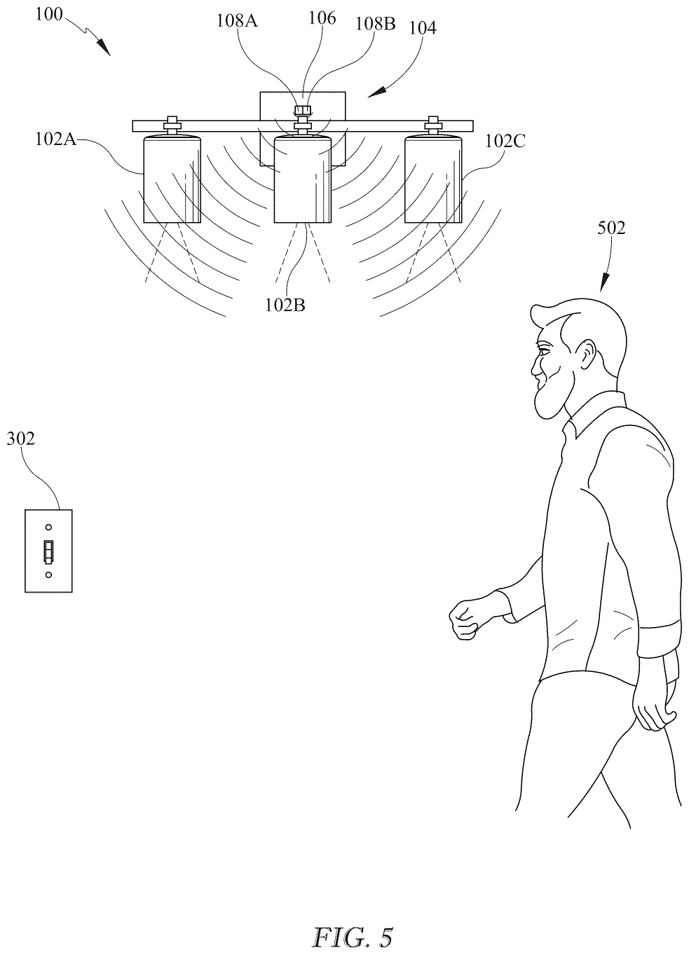

FIG. 5 depicts a front perspective of an adaptive light fixture 100 when the adaptive light fixture 100 is operating in the standby mode. The switch 302 can be in the “off” position and one or more of the illumination sources 102A-C can be illuminated.

In some implementations, the light fixture 100 can also include an automatic switch for turning on the standby mode. Sensor 108B, which can be a photodiode, can, when the amount of light is below a particular threshold, and the switch 302 is in the “off” position, cause the internal battery 210 to supply power to one or more of the illumination sources, such as LEDs of the nightlight control circuit 204B which, as stated previously, may be adjacent to or concurrent with illumination sources 102A-C. The internal battery 210, in other implementations, can supply power to one or more of such illumination sources anytime the switch 302 is in the “off” position, or at anytime the illumination sources 102A-C are turned off by any other means, and the sensor 108A, which can be a motion detector, detects movement in the illumination area of the adaptive light fixture 100, when the light fixture 100 is in the standby mode.

For example, illumination sources 102A, 102B and 102C may be incandescent bulbs, depicted in relay circuit 204A of FIG. 2, or may be LEDs, or alternatively and/or additionally may include lower power LEDs as are depicted in nightlight control circuit 204B. Hence, while incandescent bulbs are depicted in the configuration of the embodiment of FIG. 2, many configurations of light emitting sources may be implemented. During nightlight standby mode however lower power light emitting sources, such as lower power LEDs as are depicted in 204B, are desirable to reduce the load on the rechargeable battery 210. In some implementations, the illumination sources 102A, 102B and 102C

When in the standby mode and one or more of the illumination sources are receiving power from the internal battery 210, one or more of the illumination sources can emit light at a brightness or intensity that is lower and less power consuming than that emitted when the adaptive light fixture 100 is operating in the illumination mode. In some implementations, a first type of light source in one or more of the illumination sources 102A-C can be different than a second type of light source in another one or more of the illumination sources 102A-C. When the adaptive light fixture 100 is in standby mode, the first type of lightbulb can be turned on, while the second type remains off. For example, in one implementation, Illumination sources 102A and 102C can have incandescent lightbulbs and illumination source 102B can have an LED. When the adaptive light fixture 100 is in nightlight mode, illumination sources 102A and 102C can remain off but illumination source 102B can illuminate its LED lightbulb. Additionally or alternatively, in other implementations the illumination sources may be combined or integrated. For example, illumination sources 102 A, B, C could be all LED with some components that are high emission/intensity and others in each source are low energy low intensity and hence low load. Similar alternative configurations may be readily implemented such as singular diodes which are driven at higher frequencies for illumination mode and lower frequencies in standby mode.

An adaptive light fixture 100 in standby mode can keep one or more of the illumination sources 102A-C illuminated for a predetermined period of time. For example, the sensor 108A can detect that a user 502 has entered the illumination area of the adaptive light fixture 100 and the adaptive light fixture 100 can illuminate one or more of the illumination sources 102A-C in response. One or more of the illumination sources 102A-C can remain illuminated for a period of time, such as 15 seconds, after the user 502 was detected by the sensor 108A. Such time delay may be implemented internally within the circuits through known implementations which may be readily integrated with the controller design discussed herein.

In other implementations, one or more of the illumination sources 102A-C may remain illuminated until the sensor 108A no longer detects motion while the adaptive light fixture 100 is in nightlight mode. For example, the adaptive light fixture can illuminate one or more illumination sources 102A-C when the sensor 108A detects that a user 502 has entered the illumination area. One or more of the illumination sources 102A-C can remain illuminated until the user 502 has left the illumination area. Once the user 502 has left the illumination area, the adaptive light fixture 100 can extinguish all the illumination sources 102A-C immediately or after a predetermined time period.

One or more of the illumination sources 102A-C can remain illuminated while the adaptive light fixture 100 is in standby mode for a predetermined period of time after a user 502 is no longer detected in the illumination area. For example, an adaptive light fixture 100 can have illuminated one or more illumination sources 102A-C in response to detecting the user 502 in the illumination area with the sensor 108A. The illumination sources 102A-C that were illuminated can remain illuminated for a period of time, such as 15 minutes, after the user 502 is no longer detected in the illumination area by the sensor 108A through a predefined or user-defined delay.

In some implementations, the sensor 108A can be a motion detector such as an infrared sensor. The adaptive light fixture 100 can be programmed such that the illumination sources 102A-C can remain off even when a sensor(s) has detected that the amount of light in the illumination area is below a threshold level and the switch 302 is in the “off” position. For example, a mode of operation can be set such that the standby mode is bypassed and not initiated when the switch is in the “off” position. In such mode, the adaptive light fixture 100 can refrain from emitting a low intensity (nightlight) light from one or more of the illumination sources 102A-C when the sensor detects motion and the other sensor determines a low light environment. For example, a predetermined switch pattern may allow the user to bypass a standard and automatic entry of the standby mode after the switch is placed in the “off” position, such as multiple-switch movements between “on” and “off”.

Described herein are many aspects of implementation for a light fixture with integrated nightlight having an automatic standby mode for low level illumination. In such a design, when the light switch is on, household electricity supplies the fixture with electricity for daytime lighting. When the light switch is turned off, a battery included in the fixture supplies the fixture with electricity for nighttime lighting. In implementations, the standby/nightlight feature only activates when the light switch is turned OFF, a photodiode detects night, and a motion sensor detects motion. In such embodiments, the photodiode determines whether daytime lighting or nightlight lighting is appropriate. Standby or nightlight mode only needs to be activated when the photodiode detects dark/night. A motion sensor may control operation of the nightlight feature. The low level light sources only need to be activated when motion is detected. The battery is charged by the household electricity supply when the switch is on, so that the battery can power the nightlight feature when the switch is off.-Most light fixtures require consistent power from a household main to operate. This fixture described herein enables a light fixture with standby/nightlight functionality to illuminate, using electricity supplied from a battery within the fixture, if and when a switch controlling household main electricity is turned off. Moreover, the fixture and standby mode conserves battery power by only illuminating if the motion sensor detects motion, the photodiode detects night, and the household electricity is not being provided, in some of the above described embodiments.

What is claimed is:

1. An adaptive light fixture, comprising:
a first illumination source and a second illumination source;
one or more sensors;
an internal battery; and
a control circuit electrically connected to the first illumination source, the second illumination source, an internal battery, and the one or more sensors, wherein the control circuit includes:
a primary circuit that controls the first illumination source when the adaptive light fixture is in a first operating mode, wherein the primary circuit is electrically connected to an external power source;
wherein the connection to the external power source is controlled by an external power switch that is in electrical communication with the control circuit, and wherein the internal battery is in electrical connection with the external power source; and
a secondary circuit that controls at least the second illumination source when the adaptive light fixture is in a second operating mode, wherein the internal battery is electrically connected to the secondary circuit when the adaptive light fixture is in the second operating mode;
wherein the first operating mode is entered when the external power switch is in an “on” position and wherein the second operating mode is entered when the external power switch is in an “off” position.

2. The adaptive light fixture of claim 1, wherein one or more of the sensors is a motion detector.

3. The adaptive light fixture of claim 1, wherein one or more of the sensors is a photodiode.

4. The adaptive light fixture of claim 1, wherein the first illumination source and the second illumination source are different types of light sources.

5. The adaptive light fixture of claim 1, wherein the first illumination source is brighter than the second illumination source.

6. The adaptive light fixture of claim 1, wherein the first illumination source is powered by the external power source in the first operating mode and the second illumination source is powered by the internal battery in the second operating mode.

7. The adaptive light fixture of claim 1, wherein the first illumination source is an incandescent light source and the second illumination source is at least one LED.

8. An adaptive light fixture comprising:
one or more illumination sources;
a motion sensor and a light sensor;
a control circuit electrically connected to the one or more illumination sources, wiring for an external power source, an internal power source, the motion sensor, and the light sensor, wherein the control circuit includes:
a primary circuit that controls one or more of the illumination sources when the adaptive light fixture is in a first operating mode, wherein the primary circuit is connected to the external power source;
wherein the connection to the external power source is controlled by an external power switch that is in electrical communication with the control circuit, and wherein the internal power source is in electrical connection with the external power source; and
a secondary circuit that controls one or more of the illumination sources when the adaptive light fixture is in a second operating mode, wherein the internal power source is electrically connected to the secondary circuit when the adaptive light fixture is in the second operating mode.

9. The adaptive light fixture of claim 8, wherein the motion sensor is an infrared sensor.

10. The adaptive light fixture of claim 8, wherein the light sensor is a photodiode.

11. The adaptive light fixture of claim 8, wherein a first illumination source of the one or more illumination sources is a different type of illumination source than a second illumination source of the one or more illumination sources.

12. The adaptive light fixture of claim 11 further comprising a bank of LEDs as the first illumination source and a plurality of separate LEDs as the second illumination source.

13. A method for controlling function of a light fixture comprising:
extinguishing, in response to an input received from an external light switch, a first illumination source of the light fixture;
wherein prior to receiving the input, the first illumination source of the light fixture is connected to a primary electrical supply controlled through the external light switch and wherein the primary electrical supply is also connected to an internal rechargeable battery within the light fixture;
receiving, from a light sensor at a control circuit of the light fixture, a first signal that indicates that a brightness measure in an illumination area of the light fixture has fallen below a threshold light level;
receiving, from a motion sensor electrically connected to the control circuit of the light fixture, one or more second signals that indicates movement of an entity in the illumination area of the light fixture;
activating, in response to receiving the first signal and one or more of the second signals, an electrical connection between a second illumination source and the internal rechargeable battery of the light fixture; and
illuminating, in response to activating the electrical connection, a second illumination source of the light fixture.

14. The method of claim 13, wherein the second illumination source emits light at a lower intensity than the first illumination source.

15. The method of claim 13, wherein the input received from a user is a manipulation of the external light switch into an “off” position.

16. The method of claim 13, wherein the internal rechargeable battery is charged while the first illumination source is illuminated.

17. The method of claim 16, wherein the input received from the user causes the first illumination source of the light fixture to be extinguished while maintaining an electrical current flow from the external power source to charge the internal battery.

18. The method of claim 13 further comprising extinguishing the second illumination source in response to ceasing receiving one or more of the second signals.

19. The method of claim 18, wherein extinguishing the second illumination source further comprises ceasing receiving one or more of the second signals for a threshold period of time.
